(19) United States
(12) Patent Application Publication
(10) Pub. No.: US 2018/0158440 A1
(43) Pub. Date: Jun. 7, 2018

(54) VISUAL FEEDBACK DEVICE

(71) Applicant: Bradley Ronald Kroehling, Merritt Island, FL (US)

(72) Inventor: Bradley Ronald Kroehling, Merritt Island, FL (US)

(21) Appl. No.: 15/826,870

(22) Filed: Nov. 30, 2017

Related U.S. Application Data
(60) Provisional application No. 62/429,232, filed on Dec. 2, 2016.

(51) Int. Cl. G10H 1/32; G10H 1/00

(52) U.S. Cl. CPC G10H 1/32; A63H 27/10; G10H 1/0008

(57) ABSTRACT

The visual feedback device bridges the gap between what an observer sees and hears, by creating a new kind of MIDI drum kit, one that responds with obvious visual physical feedback to the specific way that the user can play it. Aggressive strikes may result in more aggressive visual feedback from the visual feedback device, and light playing may result in more subtle visual feedback from the visual feedback device giving the listener a truly unique experience.

### CROSS REFERENCE TO RELATED APPLICATIONS

This application claims priority to and the benefit of the filing date of U.S. Provisional Application No. 62/429,232, filed on Dec. 2, 2016 which is hereby incorporated by reference in its entirety.

### BACKGROUND

The present disclosure relates to a device that can be used to play music.

### DESCRIPTION OF THE RELATED ART

Current MIDI drum kits (or electronic drum kits) serve a very basic and simple function, to record hits on pressure sensitive pads and convert those hits into Musical Instrument Digital Interface (or “MIDI”) data, which can then be used to make music. Currently, there are no MIDI drum kits that exhibit a physical, visual response to the hits of a user. Imagine watching someone jump into a swimming pool without seeing any splash, but hearing one anyway. This creates a stark disconnect between what the listener hears and what they see happening on stage or in a video.

### BRIEF SUMMARY OF THE INVENTION

The visual feedback device will solve this problem by having the trigger pads cave inward when struck and then bounce outward after every hit. The harder the user strikes a trigger pad, the more intense the physical response from the trigger pad may be. Not only will the individual trigger pads show visual feedback, but the entire visual feedback device will show visual feedback as well because in some embodiments all of the trigger pads may be physically connected to one another on the skin of the visual feedback device. This will bridge the gap between what an observer sees and hears.

### BRIEF DESCRIPTION OF THE DRAWINGS

FIG. 1 shows the whole visual feedback device in accordance with some embodiments of the present invention, taken slightly to the left of where the user may stand.

FIG. 2 shows the trigger pad 14 peeled back to show how it is attached to the body 10 in accordance with some embodiments of the present invention.

FIG. 3 shows a trigger pad being integrated within the skin of the body of the visual feedback device.

FIG. 4 is a view of the underside of the trigger pad 14 before it is attached to the outside of the body in accordance with some embodiments of the present invention.

FIG. 5 shows the bottom of the visual feedback device, with the trigger module 28 and the wires 16 connecting to it in accordance with some embodiments of the present invention.

FIG. 6 shows the main feature of the visual feedback device, in order of events from A to B to C in accordance with some embodiments of the present invention.

FIG. 7 shows the visual feedback device being used by a player/user. The images are in order of events from A-D alphabetically in accordance with some embodiments of the present invention.

FIG. 8 shows the underside of an embodiment of the visual feedback device, viewing upwards from underneath it in accordance with some embodiments of the present invention.

### DETAILED DESCRIPTION AND BEST MODE OF IMPLEMENTATION

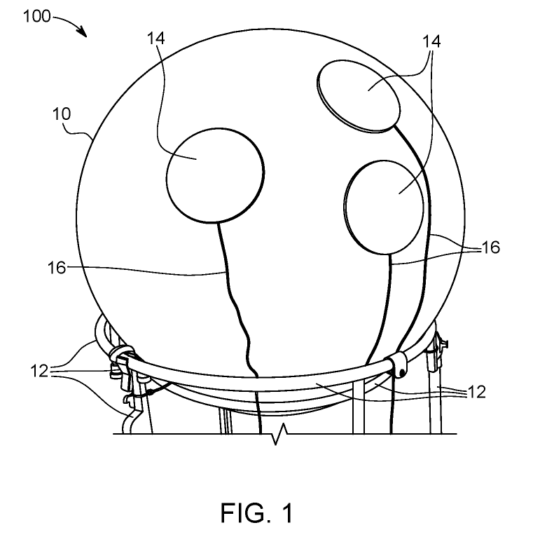

A visual feedback device 100 according to an embodiment is shown in FIG. 1. The body 10 of the visual feedback device 100 can be any resilient or flexible object such as a balloon or ball including a weather balloon however, any spherical object or other suitably shaped object that reacts physically to being struck, such as a yoga ball, Wubble Bubble ball, or any other kind of inflatable sphere or the like may be used to form the body 10 of the visual feedback device 100. In some embodiments, the body 10 sits inside a support system 12, which keeps it firmly in place and raises it approximately four feet upward above the floor. The height can be adjustable to accommodate the users needs. The support system 12 accomplishes two things, the first being that it raises the body 10 so that the user can play it upright, and the second being that it holds the body firmly in place so that it doesn't move beyond the user's reach. A support 12 is not necessary for the visual feedback device 100 to function, as another person could hold the visual feedback device with their hands. It should be appreciated to one of skill in the art that the support 12 does not have to look specifically like it does in the embodiment presented herein and other suitable types of support 12 may be used to support the visual feedback device 100. In some embodiments, the trigger pads 14 are attached to the exterior of the body 10. There are seven trigger pads on some of the embodiments of the visual feedback device 100, however, the amount, orientation, size, material composition, weight, and thickness of the trigger pads 14 on, in, or beneath the body of a visual feedback device 100 can be customized according to the user's desired visual feedback device setup. The wires 16 connect the trigger pads 14 to a trigger module/interface beneath the visual feedback device 100. The trigger module/interface then converts the data from the trigger pads into MIDI data which can then be sent to a computer.

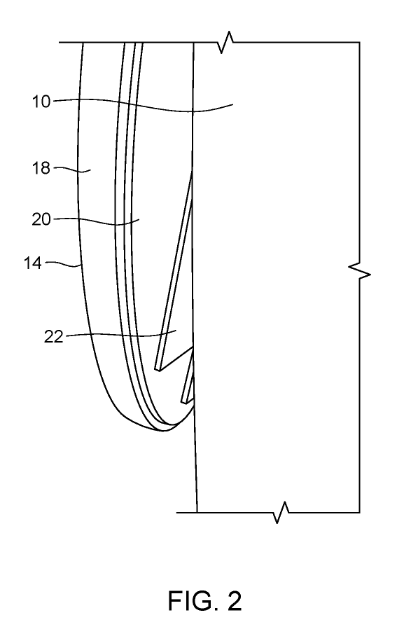

FIG. 2 shows one example of how the trigger pads 14 may be incorporated onto the body 10. For the purpose of this patent application, the image used for FIG. 2 shows a trigger pad 14 being intentionally peeled back away from the body 10 to show the underside of the pad. Normally the undersides of the trigger pads 14 are not visible because they are touching the body 10 and may be flush with the surface of the body 10. The trigger pad cushion 18 can be attached via adhesive such as super glue or by other suitable means to the outside of a trigger-extending disc 20. A trigger cushion 18 is not required for the trigger pad 14 to function properly, but it can be preferred because it protects the piezo-extending disc 20 from being damaged from excessive strikes from the user. In this embodiment of the visual feedback device, mouse pads are used for a trigger pad cushion 18, but other suitable pads or cushioning material may be used. The material used for the trigger pad cushion 18 may vary, any shock absorbent material will suffice. The material used to attach the trigger pad cushion 18 to the trigger-extending disc 20 may vary. In some embodiments, a trigger-extending disc 20 is taped with double-sided tape 22 to the body 10. The way that the pad is attached to the body 10 may vary. The material used to attach a trigger-extending disc 20 to the body 10 may vary. It does not have to be tape specifically and other suitable adhesives, hook and loop style fasteners, or other attachment means may be used.

In some embodiments of the MIDI Drum, the trigger pads 14 are attached to the exterior of the body 10 via tape 22. However, this is not the only method in which the pads can be integrated onto the body 10. Other methods of applying the trigger pads 14 onto the body 10 include but are not limited to the following

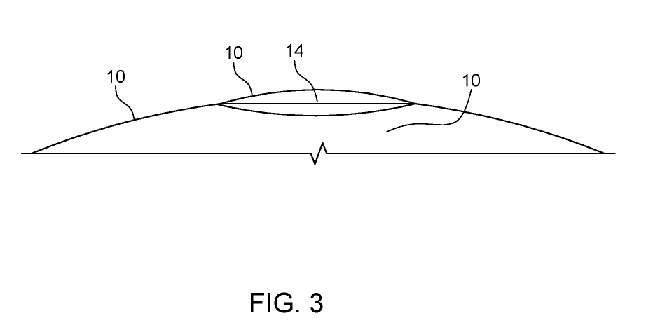

1) In a situation where the trigger pads 14 are integrated into the skin of the body 10 as seen in FIG. 3. Rather than being attached to the outside or underside of the body. The material that makes up the body of the visual feedback device would go around the trigger pad, completely covering it.

2) The trigger pads 14 are on the inside of the body 10 rather than outside.

3) Any other integration of the trigger pads 14 onto the body 10 where as a hit onto the pad physically alters the state of the visual feedback device body, while also recording and/or transmitting the physical impact data from the trigger pad to an external computer or module/interface.

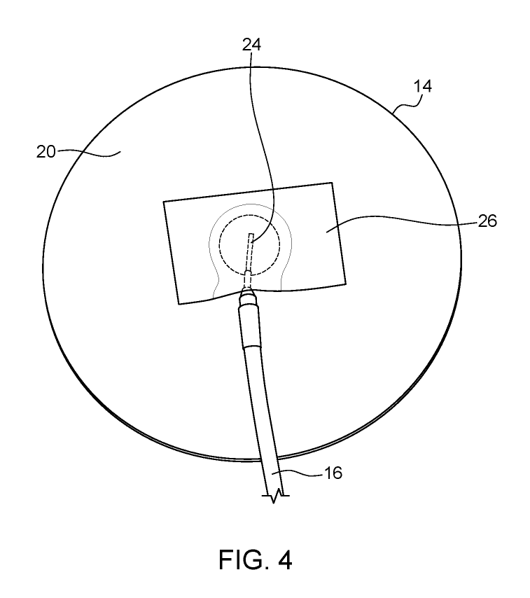

FIG. 4 shows the underside of a trigger pad 14 before being attached to the body 10. In this embodiment, all of the trigger-extending-discs 20 are made with an acrylic plastic disc but other suitable materials may be used. In this embodiment of the present disclosure, the trigger-extending disc 20 is custom cut at 16ga thick and seven inches in diameter but other suitable thicknesses and diameters may be used. The trigger-extending disc 20 extends the range of the piezo-electric transducer 24 as well as protecting the piezo-electric transducer 24 from being damaged by the user's playing. The shape, length, thickness, and material composition of the trigger-extending disc 20 may vary; it does not have to be acrylic plastic disc, or even a disc at all. For example, in some embodiments of the visual feedback device, cardboard squares instead of acrylic disks may be used.

In some embodiments, attached to the underside of the trigger-extending disc 20 can be a piezo-electric transducer 24, which can be taped to the bottom of the trigger-extending disc 20 using scotch tape 26 or other suitable means. The kind of tape or material used to physically attach the piezo-electric transducer 24 to the trigger-extending disc 20 can vary; it does not have to be scotch tape and may be other suitable fasteners or adhesives.

In some of the embodiments of the visual feedback device, piezo-electric transducers (also known as contact microphones) were used, however other methods of creating electrical signals/impulses via a deliberate strike exist. Anything that can transmit the impulse of a hit from a user can be acceptable; it does not have to be a piezo-electric transducer.

The piezo-electric transducer 24 in some embodiments of the visual feedback device may be coated in rubber to protect it from intense drumming. The piezo-electric transducer 24 does not need to be coated in a protective material. The piezo-electric transducer 24 can be connected to a cable 16. The cable 16 in the embodiments shown runs approximately 2 meters in length. The length and size of the cable 16 may vary. The other end of the cable 16 may be a TS cable, also known as a mono quarter-inch cable, a mono audio jack, mono aux cable, or a mono eight-inch cable. A TRS cable can also be used, also known as a stereo quarter-inch cable, stereo audio jack, stereo aux cable, or a stereo eighth-inch cable.

A cable 16 is not required to transmit the piezo data to the midi interface or the computer. For example, a wireless method of transmitting this information can be acceptable.

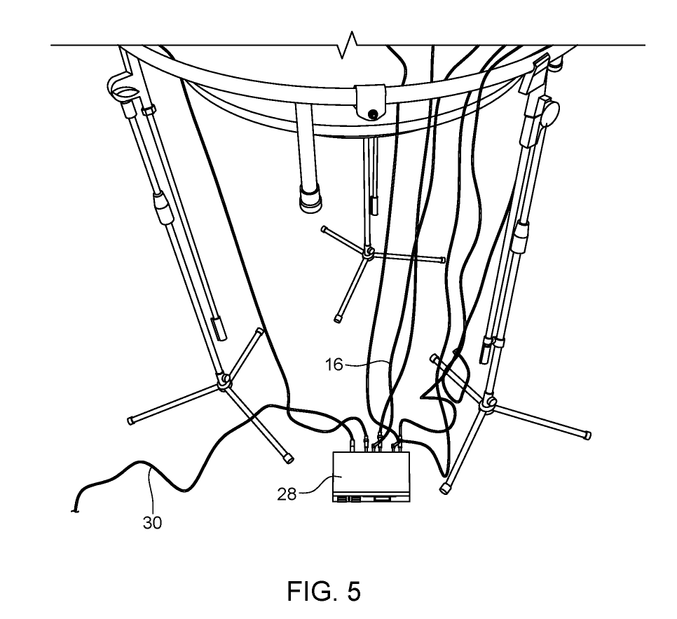

Referring now to FIG. 5. The cables 16 in this embodiment are connected to a drum trigger interface 28. In this embodiment of the visual feedback device, the ddrum DDTi is used. In the previous embodiments, the trigger interface that came with the Pyle Pro PED04 was used. The type of trigger interface 28, the manufacturer, the brand, and the modal may vary. This interface 28 converts electrical signal from the piezo-electric transducer 24 into programmable MIDI data, which is sent out via a cable 30 such as a USB or MIDI cable into a computer. In some embodiments, the MIDI trigger interface 28 may not be required for the visual feedback device to work, in the case that someone wirelessly transmits the data from the piezos to a computer or interface directly.

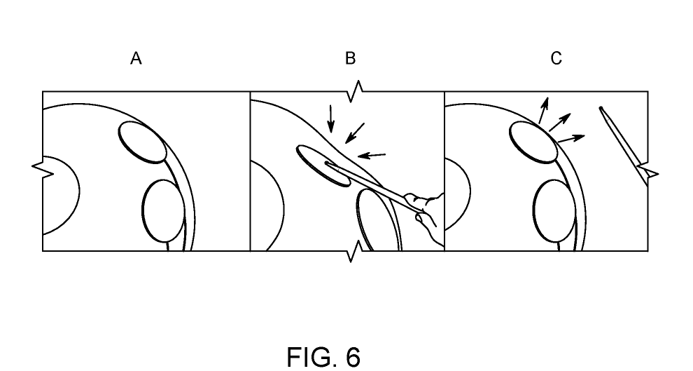

FIG. 6 shows a very basic and up close demonstration of the visual feedback device 100 in use as being struck by a user. Because the trigger pads 14 are physically attached to the body 10, the hits from the user create a very visible physical feedback. When the trigger pad 14 is struck, it caves into the body 10 before ejecting outward. This physical feedback can be used to make the music and sounds of the triggered audio look as loud as they sound. FIG. 6 shows each event in order, from A to B to C. On image A, when not hit, the trigger pad is in its resting position. On image B, when struck, the trigger pad, and also the body (in this case a balloon) cave inward. On image C, after being struck, the trigger pad 14, and entire body (body 10), physically lunge outward. The entire visual feedback device shows visible physical feedback.

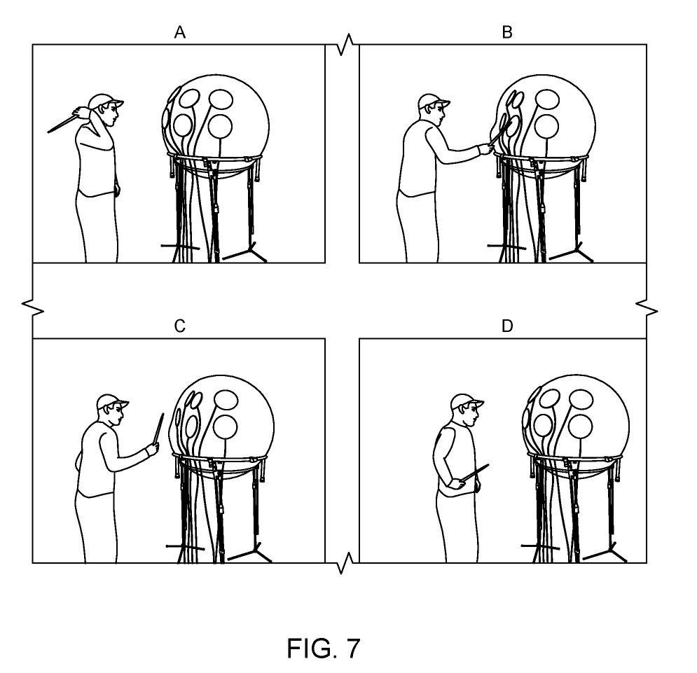

FIG. 7 shows the entire visual feedback device 100 reacting to individual strikes. There are 4 images in this figure. The images in FIG. 7 are in order of events, from A to D in alphabetical order.

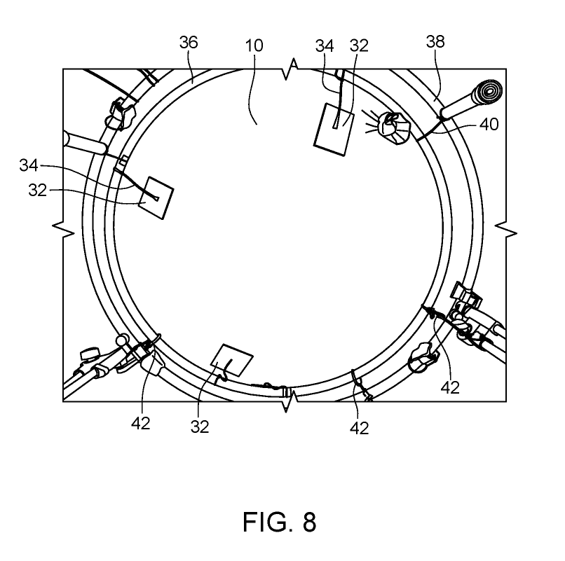

FIG. 8 shows the underside of an embodiment of the visual feedback device. The viewing angle of this figure is facing skyward from below the visual feedback device. The restraint pieces 32 are attached to the body 10 directly by tape or other suitable means. The way that the restraint pieces 32 are attached to the body 10 may vary. The material used to attach the restraint pieces 32 to the body 10 may vary. It does not have to be tape specifically and other suitable adhesives, hook and loop style fasteners, or other attachment means may be used. The restraint pieces 32 may be tied with string 34 to the lower ring 36. This helps restrain the body 10, and prevents it from leaving the support 12. The lower ring 36 is connected to the larger ring 38 via string 40 and bungee cables 42. This smaller, lower ring 36 catches the body 10 from falling through the larger ring 38.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The visual feedback device is a unique instrument that can visually express the music played with it. Current MIDI instruments of this kind do not express any physical movement when utilized; the visual feedback device may solve this problem. From the drummer's own preference, it may be a preferred way of interacting with music. This is ultimately why I built it. I was not satisfied with using a standard MIDI Drum Kit and wanted to interact with my music in a more expressive, and in my opinion impressive way. Similar or different benefits may be enjoyed by other embodiments of the invention.

What is claimed is:

1. A visual feedback device, the device comprising:
a spherical shaped body, the body comprising a resilient material;
a trigger pad coupled to the body, the trigger pad configured to transmit data upon being struck by a user;
an interface configured to convert the data from the trigger pad into MIDI data capable of being read by a computer; and
wherein the body is visually deformed when the trigger pad is struck by the user.
